(19) United States
(12) Patent Application Publication
(10) Pub. No.: US 2017/0025674 A1
(43) Pub. Date: Jan. 26, 2017

(54) OPTIMUM ELECTRONIC AND IONIC CONDUCTIVITY RATIOS IN SEMI-SOLID ELECTRODES

(71) Applicants: Taison TAN, Cambridge, MA (US); Naoki OTA, Lexington, MA (US); William WOODFORD, Cambridge, MA (US); Jeffry DISKO, North Brookfield, MA (US); Takaaki FUKUSHIMA, Okayama (JP); Lauren SIMPSON, Somerville, MA (US); Richard HOLMAN, Wellesley, MA (US); Mihai DUDUTA, Somerville, MA (US); Hiuling Zoe YU, Quincy, MA (US)

(72) Inventors: Taison TAN, Cambridge, MA (US); Naoki OTA, Lexington, MA (US); William WOODFORD, Cambridge, MA (US); Jeffry DISKO, North Brookfield, MA (US); Takaaki FUKUSHIMA, Okayama (JP); Lauren SIMPSON, Somerville, MA (US); Richard HOLMAN, Wellesley, MA (US); Mihai DUDUTA, Somerville, MA (US); Hiuling Zoe YU, Quincy, MA (US)

(21) Appl. No.: 15/013,497

(22) Filed: Feb. 2, 2016

Related U.S. Application Data
(60) Provisional application No. 62/111,353, filed on Feb. 3, 2015.

(51) Int. Cl. H01M 4/06; H01M 10/0569; H01M 4/64; H01M 10/0525; H01M 10/0568

(52) U.S. Cl. CPC H01M 4/06; H01M 10/0525; H01M 10/0568; H01M 4/64; H01M 10/0569; H01M 2004/021

(57) ABSTRACT

An energy storage device includes a positive electrode current collector, a negative electrode current collector and a separator disposed between the positive electrode current collector and the negative electrode current collector. The separator is spaced from the positive electrode current collector, thereby at least partially defining a positive electroactive zone, and the separator may be spaced from the negative electrode current collector, thereby at least partially defining a negative electroactive zone. The energy storage device includes a semi-solid electrode with a thickness in the range of about 200 μm to about 2,000 μm, located in the positive electroactive zone and/or the negative electroactive zone. The semi-solid electrode may also include a suspension of an ion-storing solid phase material in a non-aqueous liquid electrolyte.

### CROSS-REFERENCE TO RELATED APPLICATIONS

This application claims priority to and the benefit of U.S. Provisional Patent Application Ser. No. 62/111,353, filed Feb. 3, 2015 and titled “Optimum Electronic and Ionic Conductivity Ratios in Semi-Solid Electrodes,” the disclosure of which is hereby incorporated by reference in its entirety.

### BACKGROUND

As the demand for batteries having better electronic performance, for example, higher charge capacity, energy density, conductivity, and rate capabilities increases, new electrode designs are needed to meet these criteria. Lithium-ion cells made with thick electrodes (e.g., greater than 200 μm) have characteristics and requirements that differ from lithium-ion cells made with thinner electrodes (e.g., less than 200 μm). For example, lithium-ion electrodes and particularly anodes suffer from plating at the current collector side and this phenomenon is not generally observed in thinner electrodes.

### SUMMARY

Embodiments described herein relate generally to energy storage devices (e.g., electrochemical cells, electrodes for use in electrochemical cells, batteries, and modules comprising one or more stacked electrochemical cells) having improved performance and lifespan, and more particularly, to electrodes having an electronic conductivity that exceeds its ionic conductivity, resulting in greater cycle life and overall cell performance. In some embodiments, an energy storage device includes a positive electrode current collector, a negative electrode current collector and a separator disposed between the positive electrode current collector and the negative electrode current collector. The separator is spaced from the positive electrode current collector, thereby at least partially defining a positive electroactive zone, and the separator is spaced from the negative electrode current collector, thereby at least partially defining a negative electroactive zone. A semi-solid electrode having a thickness in the range of about 200 μm to about 2,000 μm is disposed in at least one of the positive electroactive zone and the negative electroactive zone. The semi-solid electrode includes a suspension of an ion-storing solid phase material in a non-aqueous liquid electrolyte, and has a ratio of electronic conductivity to ionic conductivity greater than about 15.

### BRIEF DESCRIPTION OF THE DRAWINGS

FIG. 1 is a schematic illustration of an electrochemical cell according to an embodiment.

FIG. 2A is a schematic illustration of an anode having a conductivity ratio less than 15, according to an embodiment.

FIG. 2B is a schematic illustration of an anode having a conductivity ratio greater than 15, according to an embodiment.

FIG. 3 shows the energy efficiency of electrochemical cells after multiple charge and discharge cycles, according to various embodiments.

FIG. 4 shows the energy efficiency of electrochemical cells after multiple charge and discharge cycles, according to various embodiments.

FIG. 5 shows the energy efficiency of electrochemical cells after multiple charge and discharge cycles, according to various embodiments.

FIG. 6 shows the capacity retention of electrochemical cells after multiple charge and discharge cycles, according to various embodiments.

FIG. 7 shows the relative ionic transport, as a function of the active volume fraction, of electrochemical cells according to various embodiments.

### DETAILED DESCRIPTION

Electronic conductivity (σₑ) and ionic conductivity (σᵢ) are important characteristics of battery electrodes that can affect the performance and life of the electrochemical cell. Conventionally, both electronic and ionic conductivities have been viewed as parameters to be maximized in order to improve the performance of a cell, for example because higher ionic conductivity can lead to a more favorable C-rate (the rate at which a battery is discharged relative to its maximum capacity). However, for “thick electrodes” (e.g., electrodes having a thickness greater than about 200 μm), higher ionic conductivities can also lead to performance degradation (e.g., delamination of an anode from its current collector). According to embodiments of the present disclosure, performance of energy storage devices having thick-electrodes is enhanced (e.g., higher energy efficiencies are realized), and/or their useful life is extended, due to an optimum relationship between an ionic conductivity thereof (e.g., of an electrolyte and/or electrode) and an electronic conductivity of the electrode (e.g., an optimal “ratio” of electronic conductivity to ionic conductivity). Specifically, embodiments of the present disclosure relate to maintaining an electronic conductivity greater than a corresponding ionic conductivity (e.g., of an electrolyte and/or electrode), in order to provide optimal electrode (e.g., anode) characteristics for a given electrochemical cell, including those made using thick “semi-solid” electrodes. Examples of electrochemical cells utilizing thick semi-solid electrodes and various formulations thereof are described in U.S. Patent Application Publication No. 2014/0170524 (also referred to as “the '524 publication”), published Jun. 19, 2014 and entitled “Semi-Solid Electrodes Having High Rate Capability”, U.S. Patent Application Publication No. 2014/0315097 (also referred to as “the '097 publication”), published Oct. 23, 2014 and entitled “Asymmetric Battery Having a Semi-Solid Cathode and High Energy Density Anode” and U.S. Provisional Patent Application No. 62/074,372, filed Nov. 3, 2014 and entitled “Pre-Lithiation of Electrode Materials in a Semi-Solid Electrode”, the entire disclosures of which are incorporated by reference herein.

In some embodiments, the electrode materials described herein can be a flowable semi-solid or condensed liquid composition. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. The amount of active material present in a given formulation can be referred to as an “active loading.” Examples of battery architectures utilizing semi-solid suspensions are described in International Patent Publication No. WO 2012/024499, entitled “Stationary, Fluid Redox Electrode,” and International Patent Publication No. WO 2012/088442, entitled “Semi-Solid Filled Battery and Method of Manufacture,” the entire disclosures of which are hereby incorporated by reference.

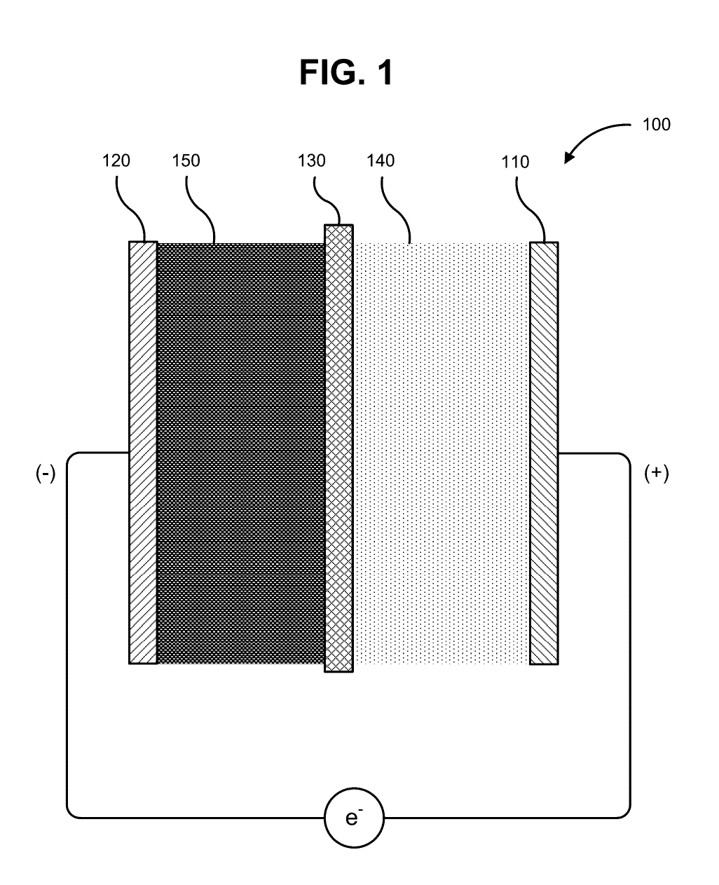

FIG. 1 shows a schematic illustration of an electrochemical cell 100. The electrochemical cell 100 includes a positive current collector 110, a negative current collector 120, and a separator 130 disposed between the positive current collector 110 and the negative current collector 120. The positive current collector 110 is spaced from the separator 130 and at least partially defines a positive electroactive zone. The negative current collector 120 is spaced from the separator 130 and at least partially defines a negative electroactive zone. A semi-solid cathode 140 is disposed in the positive electroactive zone and an anode 150 (e.g., a semi-solid anode) is disposed in the negative electroactive zone.

The semi-solid cathode and/or anode can be disposed on a current collector, for example, by coating, casting, drop coating, pressing (e.g., roll pressing), or deposition using any other suitable method. The semi-solid cathode can be disposed on the positive current collector and the semi-solid anode can be disposed on a negative current collector. For example the semi-solid electrode can be coated, casted, calendered and/or pressed on the current collector. The positive current collector 110 and the negative current collector 120 can be any current collectors that are electronically conductive and are electrochemically inactive under the operation conditions of the cell. Typical current collectors for lithium cells include copper, aluminum, or titanium for the negative current collector and aluminum for the positive current collector, in the form of sheets or mesh, or any combination thereof.

Current collector materials can be selected to be stable at the operating potentials of the positive and negative electrodes of an electrochemical cell 100. For example, in non-aqueous lithium systems, the positive current collector can include aluminum, or aluminum coated with conductive material that does not electrochemically dissolve at operating potentials of 2.5-5.0V with respect to Li/Li+. Such materials include platinum, gold, nickel, conductive metal oxides such as vanadium oxide, and carbon. The negative current collector can include copper or other metals that do not form alloys or intermetallic compounds with lithium, carbon, and/or coatings comprising such materials disposed on another conductor. The semi-solid cathode and the semi-solid anode included in an electrochemical cell can be separated by a separator. For example, the separator 130 can be any conventional membrane that is capable of ion transport (also referred to herein as “an ion permeable membrane”). In some embodiments, the separator 130 is a liquid impermeable membrane that permits the transport of ions therethrough, namely a solid or gel ionic conductor.

The cathode 140 can be a semi-solid stationary cathode or a semi-solid flowable cathode, for example of the type used in redox flow cells. The cathode 140 can include an active material, such as a lithium bearing compound as described in further detail below. The cathode 140 can also include a conductive material such as, for example, graphite, carbon powder, pyrolytic carbon, carbon black, carbon fibers, carbon micro fibers, carbon nanotubes (CNTs), single walled CNTs, multi walled CNTs, fullerene carbons including “bucky balls,” graphene sheets and/or aggregate of graphene sheets, any other conductive material, alloys or combination thereof. The cathode 140 can also include a non-aqueous liquid electrolyte as described in further detail below.

In some embodiments, the anode 150 can be a semi-solid stationary anode. In some embodiments, the anode 150 can be a semi-solid flowable anode, for example, of the type used in redox flow cells.

The anode 150 can also include a carbonaceous material such as, for example, graphite, carbon powder, pyrloytic carbon, carbon black, carbon fibers, carbon microfibers, carbon nanotubes (CNTs), single walled CNTs, multi walled CNTs, fullerene carbons including “bucky balls”, graphene sheets and/or aggregate of graphene sheets, any other carbonaceous material or combination thereof. In some embodiments, the anode 150 can also include a non-aqueous liquid electrolyte (e.g., for a lithium-ion (Li-ion) rechargeable battery, may be one or more alkyl carbonates, or one or more ionic liquids). In some embodiments, the semi-solid cathode 140 and/or anode 150 can include a non-aqueous liquid electrolyte that can include polar solvents such as, for example, alcohols or aprotic organic solvents. Numerous organic solvents have been proposed as the components of Li-ion battery electrolytes, notably a family of cyclic carbonate esters such as ethylene carbonate, propylene carbonate, butylene carbonate, and their chlorinated or fluorinated derivatives, and a family of acyclic dialkyl carbonate esters, such as dimethyl carbonate, diethyl carbonate, ethylmethyl carbonate, dipropyl carbonate, methyl propyl carbonate, ethyl propyl carbonate, dibutyl carbonate, butylmethyl carbonate, butylethyl carbonate and butylpropyl carbonate. Other solvents proposed as components of Li-ion battery electrolyte solutions include y-butyrolactone, dimethoxyethane, tetrahydrofuran, 2-methyl tetrahydrofuran, 1,3-dioxolane, 4-methyl-1,3-dioxolane, diethyl ether, sulfolane, methylsulfolane, acetonitrile, propiononitrile, ethyl acetate, methyl propionate, ethyl propionate, dimethyl carbonate, tetraglyme, and the like. These nonaqueous solvents are typically used as multicomponent mixtures, into which a salt is dissolved to provide ionic conductivity. Exemplary salts to provide lithium conductivity include LiClO₄, LiPF₆, LiBF₄, LiTFSI, LiBETI, LiBOB, LiFSI and the like. Side reactions occurring in electrochemical cells (e.g., the formation of a solid electrolyte interphase, “SEI”) may depend upon the salt used. In some embodiments, LiFSI produces a more stable cell.

In some embodiments, an energy storage device includes a positive electrode current collector, a negative electrode current collector and a separator disposed between the positive electrode current collector and the negative electrode current collector. The separator is spaced from the positive electrode current collector, thereby at least partially defining a positive electroactive zone. The separator is also spaced from the negative electrode current collector, thereby at least partially defining a negative electroactive zone. The energy storage device also includes at least one semi-solid electrode, having a thickness in the range of about 200 μm to about 2,000 μm, disposed in the positive electroactive zone and/or the negative electroactive zone. The semi-solid electrode includes a suspension of an ion-storing solid phase material in a non-aqueous liquid electrolyte. The semi-solid electrode can have a ratio of electronic conductivity to ionic conductivity greater than about 15. In some embodiments, the semi-solid electrode can have an electronic conductivity of at least about 150 mS/cm and an ionic conductivity of less than about 10 mS/cm.

In some embodiments, an energy storage device includes a positive electrode current collector, a negative electrode current collector and a separator disposed between the positive electrode current collector and the negative electrode current collector. The energy storage device includes a positive electrode positioned between the positive electrode current collector and the separator, so that the positive electrode current collector and the separator define a positive electroactive zone therebetween that can accommodate the positive electrode. The energy storage device also includes a negative electrode positioned between the negative electrode current collector and the separator, so that the negative electrode current collector and the separator define a negative electroactive zone therebetween that can accommodate the negative electrode. At least one of the positive electrode and the negative electrode includes a semi-solid electrode with a thickness in the range of about 200 μm to about 2,000 μm and includes a suspension of an ion-storing solid phase material in a non-aqueous liquid electrolyte. The semi-solid electrode can have a ratio of electronic conductivity to ionic conductivity greater than about 15.

In some embodiments, an energy storage device includes a positive electrode current collector, a negative electrode current collector and a separator disposed between the positive electrode current collector and the negative electrode current collector. The separator is spaced from the positive electrode current collector, thereby at least partially defining a positive electroactive zone. The separator is also spaced from the negative electrode current collector, thereby at least partially defining a negative electroactive zone. A semi-solid electrode, with a thickness in the range of about 200 μm to about 2,000 μm, is disposed in the positive electroactive zone and/or the negative electroactive zone, and included a suspension of an ion-storing solid phase material in a non-aqueous liquid electrolyte. The semi-solid electrode can have an electronic conductivity of at least about 150 mS/cm and an ionic conductivity of less than about 10 mS/cm.

In some embodiments, an electrochemical cell includes a cathode and a semi-solid anode. The semi-solid anode includes a suspension of about 40% to about 75% by volume of an active material and 0% to about 10% by volume of a conductive material in a non-aqueous liquid electrolyte. A separator is disposed between the semi-solid anode and the cathode. In some embodiments, the semi-solid anode has a thickness in the range of about 200 μm to about 2,000 μm, an electronic conductivity of at least about 150 mS/cm, and an ionic conductivity of less than about 10 mS/cm. In some embodiments, the ratio of electronic conductivity to ionic conductivity of the semi-solid anode can be greater than about 15.

In a porous medium such as a semi-solid electrode, the ionic conductivity of an electrolyte-containing porous medium is related to the ionic conductivity of the electrolyte prior to its incorporation into the porous medium. Theoretical models have been developed to describe transport properties in porous media, but the present invention is not bound by any such particular theory. One such theory relates the ionic conductivity of an electrolyte-containing porous medium to the ionic conductivity of the electrolyte prior to its incorporation into the porous medium using two geometric parameters, called porosity and tortuosity, respectively. In the context of a semi-solid electrode, the porosity is defined as the fraction of the volume of the semi-solid electrode which is comprised by electrolyte. The tortuosity is defined as the effective non-linear path length over which transport occurs in a porous medium relative to the characteristic linear dimension of the medium. In theory and in practice, porosity and tortuosity have been found to be correlated. In battery electrodes, one such experimental study (Thorat, et al.) found the algebraic relationship between porosity and tortuosity to be given by Equation (M):

tortuosity=1.8×porosity^{-0.53} (Equation M):

In a porous medium such as a semi-solid electrode, a transport property such as the ionic conductivity or ion diffusivity of an electrolyte-containing porous medium is related to the same transport property of the electrolyte prior to its incorporation into the porous medium according to Equation (N), where T_{effective} is the transport property, such as the ionic conductivity or ion diffusivity of an electrolyte-containing porous medium, and T₀ is the same transport property of the electrolyte prior to its incorporation into the porous medium:

T_{effective}=T₀*porosity/tortuosity (Equation N):

In a battery electrode, the porosity is given as Equation (O), where “inactive additives” include any additional solid materials which are added to the electrode, including but not limited to conductive carbon additives:

porosity=1−(volume fraction of active material)−(volume fraction of binder)−(volume fraction of inactive additives) (Equation O):

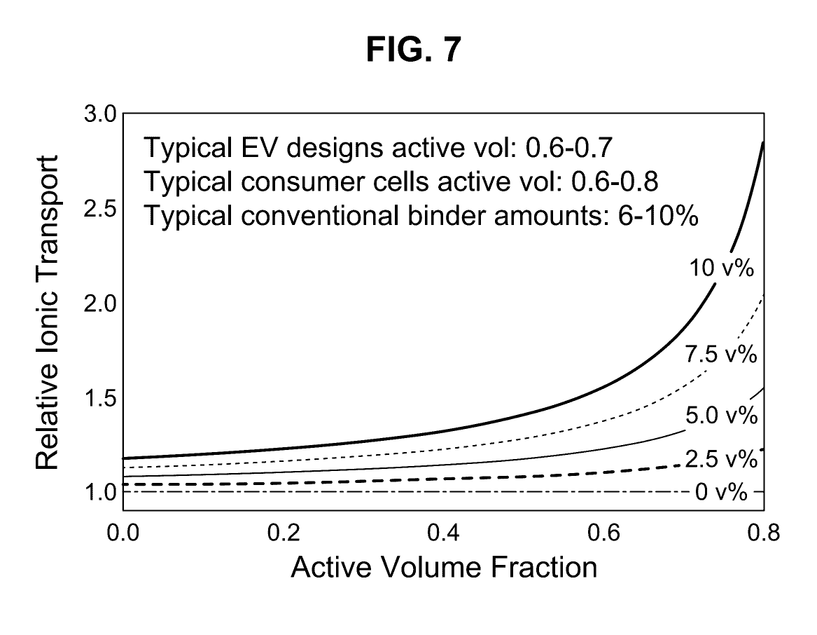

In one embodiment of a typical conventional electrode, the volume fraction of active material is 0.60 (i.e., 60%), the volume fraction of binder is 0.10 (i.e., 10%), and the volume fraction of inactive additives is 0. The porosity of such an electrode is 0.30. In some embodiments of the present invention, the volume fraction of active material is 0.60, the volume fraction of binder is 0, and the volume fraction of inactive additives is 0. The porosity of such an electrode is about 0.40. According to Equations M-O above, the value of transport property such as the ionic conductivity or ion diffusivity of an electrolyte-containing conventional electrode is about 0.088 times (i.e., 8.8% of) same transport property of the electrolyte prior to its incorporation into the porous medium. According to Equations M-O above, the value of transport property, such as the ionic conductivity or ion diffusivity of an electrolyte-containing electrode of the present invention is 0.137 times (i.e., 13.7% of) the same transport property of the electrolyte prior to its incorporation into the porous medium. Thus, the electrode of the present invention has a transport property (e.g., the ionic conductivity or ion diffusivity) that is 1.56 times (0.137/0.088=1.56) that of a conventional electrode with the same active loading. This advantage of the present invention is summarized in FIG. 7 (discussed further below) over a wide range of volume fractions of active materials and volume fractions of binder used in conventional electrodes in FIG. 7 (discussed below).

The thickness of a semi-solid electrode defines an appropriate characteristic linear dimension over which ionic transport occurs, and an appropriate figure of merit for ionic transport in a semi-solid is given by Equation (P):

Effective ionic transport length=(Electrode thickness in microns)*tortuosity/porosity (Equation P):

A typical electrode made by conventional methods for a high-power cell might have an active volume fraction of 60% and a binder volume fraction of about 6% to about 10%. Such an electrode may have a typical thickness of about 50 μm. According to Equations M & N above, the effective ionic transport length of such electrodes is about 450 μm to about 600 μm. As another example, a typical electrode made by conventional methods for a “high-energy” cell might have an active volume fraction of 75% and a binder volume fraction of about 6% to about 10%. Such an electrode may have a thickness up to 120 μm. Such electrodes have an effective ionic transport length of about 2,700 μm to about 4,000 μm. Electrodes prepared by the present method can have active volume fractions greater than 40% and binder volume fractions up to 6%, and may have thickness of about 200 μm or greater. The effective ionic transport length for such electrodes may be about 750 μm to about 10,000 μm.

In some embodiments, an electrode for use in a rechargeable battery includes an electrode compartment defined at least partially by a current collector and a separator. The electrode compartment has a thickness of about 200 μm to about 2,000 μm, and is configured to contain an electroactive composition capable of taking up or releasing ions. The electroactive composition includes a suspension of an ion-storing solid phase material in a non-aqueous liquid electrolyte, with a volume fraction of the solid ion-storing redox material between about 35% and 75%. The electroactive composition can have an electronic conductivity of at least about 150 mS/cm, and the salt concentration in the non-aqueous liquid electrolyte can be less than about 1.33M. For example, in some embodiments the salt concentration of the non-aqueous liquid electrolyte of the disclosed energy storage device is in a range of between about 0.4M and about 1.33 M, between about 0.5 and about 1.0M, or between about 0.6M and about 0.9M.

In some embodiments, the ionic conductivity of an electrolyte (e.g., a non-aqueous liquid electrolyte) or a semi-solid electrode (i.e., a suspension of an electrochemically active material (anodic or cathodic particles or particulates), and optionally an electronically conductive material (e.g., carbon) in a non-aqueous liquid electrolyte) included in the electrochemical cell 100 can be in a range of between about 5 mS/cm and about 15 mS/cm, or in a range of between about 6 mS/cm and about 9 mS/cm. In some embodiments, the ionic conductivity of the electrolyte or a semi-solid electrode can be about 5 mS/cm, about 7 mS/cm, or about 9 mS/cm. In some embodiments, the ionic conductivity of the electrolyte or semi-solid electrode can be in a range of between any two of the ionic conductivity values disclosed herein. In some embodiments, the ionic conductivity of the electrolyte or semi-solid electrode can be less than about 15 mS/cm. In some embodiments, the ionic conductivity of the electrolyte or semi-solid electrode can be less than about 10 mS/cm. In some embodiments, the ionic conductivity of a semi-solid electrode is lower than the ionic conductivity of an electrolyte included in the semi-solid electrode. In other words, the ionic conductivity of an electrolyte-containing semi-solid electrode may be lower than the ionic conductivity of the electrolyte prior to its incorporation into the semi-solid electrode.

In some embodiments, a salt concentration in a non-aqueous liquid electrolyte of the disclosed energy storage device (e.g., an electrolyte of the anode and/or the cathode) is less than about 1.33M. In some embodiments, the salt concentration of a non-aqueous liquid electrolyte of the disclosed energy storage device is in a range of between about 0.4M and about 1.33 M, between about 0.5 and about 1.0M, or between about 0.6M and about 0.9M.

In some embodiments, the electronic conductivity of the semi-solid electrode (in some embodiments comprising an electrode “slurry”) is in a range of between about 100 mS/cm and about 2,000 mS/cm. In some embodiments, the electronic conductivity of the semi-solid electrode (for an anode and/or a cathode) can be about 100 mS/cm, about 350 mS/cm, about 600 mS/cm, about 850 mS/cm, about 1,100 mS/cm, about 1,350 mS/cm, about 1,600 mS/cm, about 1,850 mS/cm, or about 2,000 mS/cm. In some embodiments, the electronic conductivity of the semi-solid electrode can be in a range of between any two of the electronic conductivity values disclosed herein. In some embodiments, the electronic conductivity of the semi-solid electrode may be at least about 150 mS/cm.

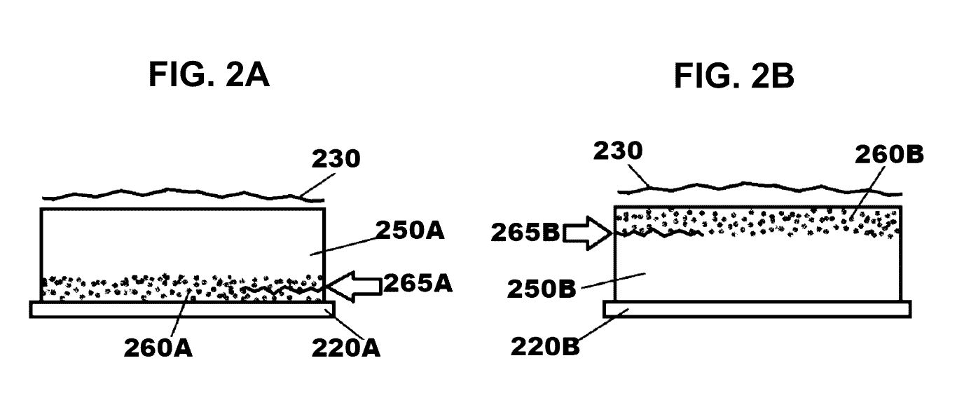

FIG. 2A depicts an electrode configuration in which the ratio (i.e., “conductivity ratio”) of the electronic conductivity (σₑ) of the electrode to the ionic conductivity (σᵢ) of a non-aqueous liquid electrolyte (and, correspondingly, of the electrode itself) is less than 15. A semi-solid anode 250A is disposed between a negative current collector 220A and a separator 230. The negative current collector 220A can be, for example, a copper foil current collector. Lithium dendrite growth 260A is shown within a region of the semi-solid anode 250A near the interface with the negative current collector 220A. In other words, lithium ions preferentially “plate” or agglomerate, by way of dendritic growth, nearest the negative current collector 220A. Without wishing to be bound by any particular theory, it is believed that the region of lithium dendrite grown 260A can be an area in which mechanical failure of the semi-solid anode 250A can occur. Disruption of the carbon network and/or increase of decomposition product (SEI) can be a cause of the phenomena of the mechanical failure of the semi-solid anode 250A. In other words, in some semi-solid anodes 250A, a mechanical failure region 265A can develop in the lithium dendrite growth region 260A near the negative current collector 220A. For example, as shown in FIG. 2A, the mechanical failure region 265A is shown very near to the interface between the region 260A of the semi-solid anode 250A having dendrites, and the negative current collector 220A.

FIG. 2B depicts a semi-solid electrode configuration according to an embodiment of the present disclosure, in which the ratio (i.e., “conductivity ratio”) of the electronic conductivity (σₑ) of the electrode to the ionic conductivity (σᵢ) of a non-aqueous liquid electrolyte (and, correspondingly, of the electrode itself) is greater than 15. In such embodiments, lithium ions are limited in their mobility within the semi-solid electrode thickness. In FIG. 2B, semi-solid anode 250B is disposed between a copper current collector 220B and separator 230. Lithium dendrite growth (260B) is shown near a region of semi-solid anode 250B that is closest to the separator 230. In other words, lithium ions preferentially “plate” or agglomerate, by way of dendritic growth, nearest the separator layer. As such, the lithium ions are conveniently positioned for diffusion out of the anode via the separator (and subsequently to diffuse back into the anode through the separator). In this configuration, should a point of mechanical failure region 265B develop, it will develop in the vicinity of the dendrited region. Disruption of the carbon network and/or increase of decomposition product (SEI) can be a cause of the phenomena of the mechanical failure of the semi-solid anode 250B. For example, as shown in FIG. 2B, mechanical failure region 265B has formed at approximately the location of the interface between the region of the semi-solid anode having dendrites and a region of the semi-solid anode without dendrites. This configuration is therefore favorable in the sense that, should a separation occur due to the mechanical failure, a significant amount of the semi-solid anode would remain attached to the current collector.

As illustrated by FIGS. 2A and 2B, there are both performance and lifespan advantages to having an electronic conductivity of an electrode that exceeds a corresponding ionic conductivity of the electrode (e.g., an ionic conductivity of the non-aqueous liquid electrolyte or an ionic conductivity of the electrode). In some embodiments of the disclosure, the conductivity ratio (defined herein as σₑ/σᵢ) is selected and/or adjusted in order to achieve optimal life and performance. For example, in some embodiments, energy storage devices of the disclosure are designed such that the conductivity ratio is greater than about 15. In some embodiments, the conductivity ratio may be greater than about 15, greater than about 20, or greater than about 30. In some embodiments, the conductivity ratio may be up to about 100. In some embodiments, the conductivity ratio may have a value in a range of between any of the foregoing numbers. For example, in some embodiments, the conductivity ratio may have a value in a range of between about 15 and about 100, or between about 20 and about 75, or between about 30 and about 50, or between about 15 and about 300, or between about 20 and about 100, or between about 30 and about 75.

Table 1 below provides a summary of parameters used in experimental tests of embodiments described herein. Tabulated data are provided for a variety of exemplary electrolyte solvent compositions (i.e., varying ratios of ethylene carbonate (EC), γ-butyrolactone (GBL), propylene carbonate (PC), and/or ethyl methyl carbonate (EMC)) and salts (i.e., varying molarities of lithium tetrafluoroborate (LiBF₄), lithium bis(trifluoromethanesulfonyl)imide (LiTFSI), or lithium tetracyanoborate (LiTCB)) with their corresponding ionic conductivities, electrode thicknesses, and energy efficiencies listed. The ionic conductivities shown in Table 1 are of the solvent/salt solution. Electrolytes prepared according to the formulations of Table 1 also included 2% vinylene carbonate (VC) and 0.5% trioctyl phosphate (TOP).

TABLE 1

| | | | | Thickness | Energy |
|---|---|---|---|---|---|
| | | | | (cathode/ | Effi- |
| Solvent | Salt | Conductivity | | anode) | ciency |
| EC-GBL 50/50 | 1.1M LiBF₄ | 7.3 | mS/cm | 300 μm/300 μm | 91% |
| EC-GBL 30/70 | 1.1M LiBF₄ | 7.4 | mS/cm | 300 μm/300 μm | 92% |
| EC-GBL 30/70 | 1.1M LiBF₄ | 7.4 | mS/cm | 394 μm/394 μm | 89% |
| EC-GBL 30/70 | 1.0M LiTFSI | 9.54 | mS/cm | 300 μm/300 μm | 92% |
| EC-GBL 50/50 | 1.0M LiTFSI | 8.46 | mS/cm | 300 μm/300 μm | 92% |
| EC-GBL 30/70 | 0.8M LiTCB | 5.10 | mS/cm | 300 μm/300 μm | 92% |

Table 2 below provides a summary of typical salt concentrations (i.e., molarities) for four salts (LiBF₄, LiTFSI, LiTCB or lithium bis(fluorosulfonyl)imide (LiFSI)) used to produce electrolytes with base solvents of either EC and GBL (see rows 1 through 4) or of linear carbonate and cyclic carbonate (see rows 5-8).

TABLE 2

| Solvent | Salt | Content |
|---|---|---|
| EC and GBL | LiBF₄ | 0.4M-2.0M |
| EC and GBL | LiTCB | 0.4M-1.0M |
| EC and GBL | LiFSI | 0.4M-1.0M |
| EC and GBL | LiTFSI | 0.4M-2.0M |
| linear carbonate + cyclic carbonate | LiBF₄ | 0.4M-0.8M |
| linear carbonate + cyclic carbonate | LiTCB | 0.4M-0.8M |
| linear carbonate + cyclic carbonate | LiFSI | 0.4M-2.0M |
| linear carbonate + cyclic carbonate | LiTFSI | 0.4M-2.0M |

The following examples show the electrochemical properties (e.g., energy efficiency over multiple charge/discharge cycles) of various electrochemical cells that include the semi-solid electrodes described herein (each having a 50% active loading). These examples are only for illustrative purposes and are not intended to limit the scope of the present disclosure.

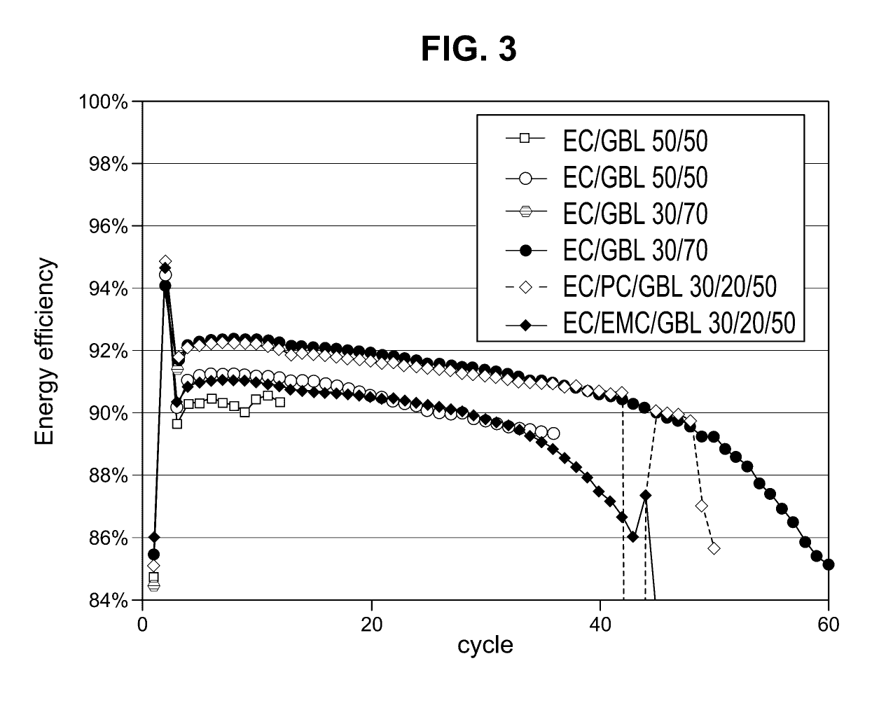

Turning now to FIG. 3, a plot of energy efficiency vs. number of charge and discharge cycles (with electrolyte compositions shown in the figure) is provided for electrochemical cells prepared according to various embodiments of the disclosure. The formulations shown in FIG. 3 included 1.5% LiBOB, 2% VC, 0.5% TOP, and 1.1M LiBF₄ (cathode and anode thicknesses were 300 μm). As shown, electrochemical cells having an anode prepared with the 30/70 EC/GBL formulation and having an ionic conductivity of 7.4 mS/cm, consistently outperformed the other tested formulations in terms of energy efficiency, and exhibited a more gradual taper after 50 charge/discharge cycles.

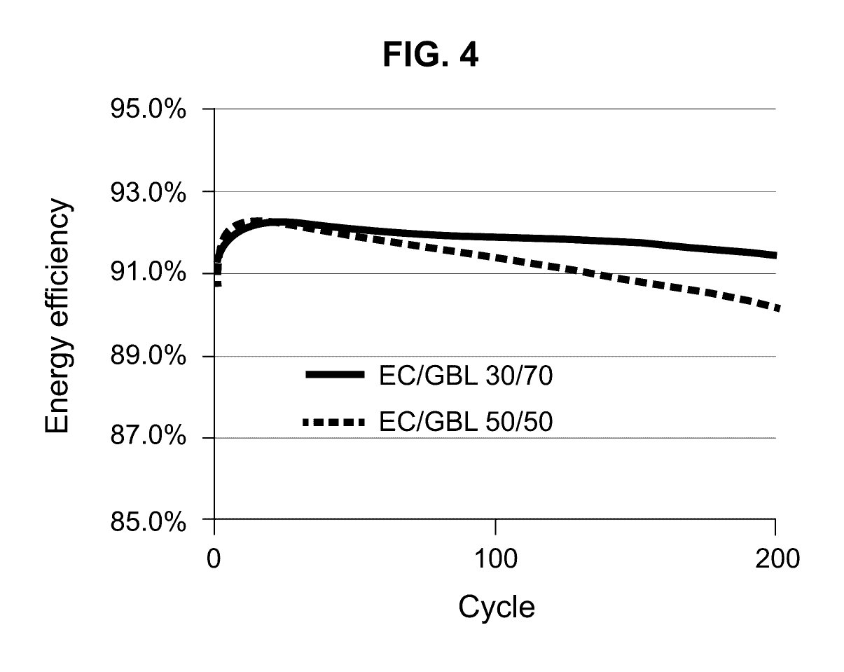

In FIG. 4, a plot of energy efficiency vs. number of charge and discharge cycles is provided for electrochemical cells prepared according to various embodiments of the disclosure. The cathode and anode thicknesses for the devices shown in FIG. 4 were both 300 μm. As shown, electrochemical cells having an anode prepared with the 30/70 EC/GBL formulation (1.0M LiTFSI, 2% VC, 0.5% TOP and 0.8% maleic anhydride) and having an ionic conductivity of 9.54 mS/cm, consistently outperformed the 50/50 EC/GBL formulation (having an ionic conductivity of 8.46 mS/cm) in terms of energy efficiency, and exhibited a more gradual taper after 50 charge/discharge cycles.

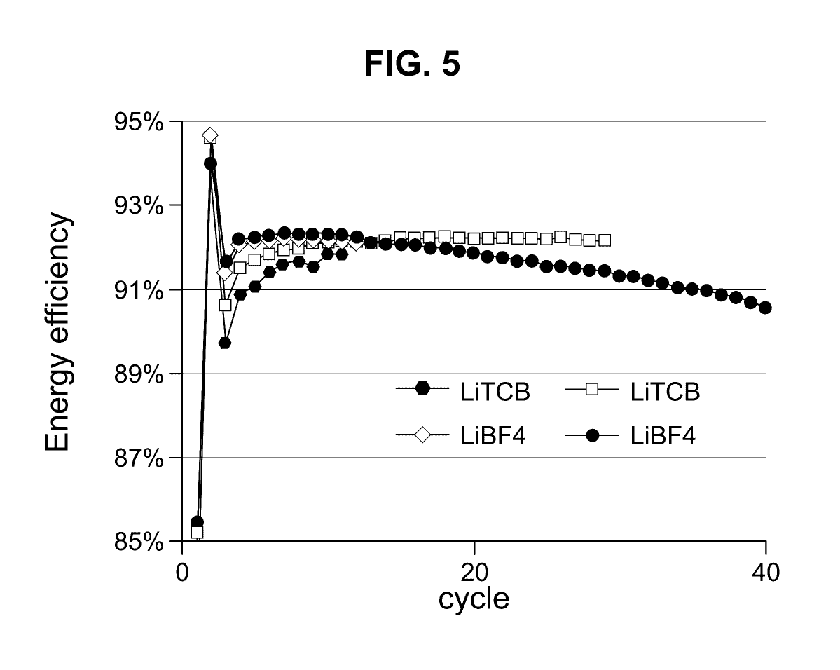

In FIG. 5, a plot of energy efficiency vs. number of charge and discharge cycles is provided for electrochemical cells prepared according to various embodiments of the disclosure, comparing anodes prepared with LiTCB (0.8M, with 2% VC and 0.5% TOP) and LiBF₄ (1.1M, with 2% VC, 1.5% LiBOB and 0.5% TOP).

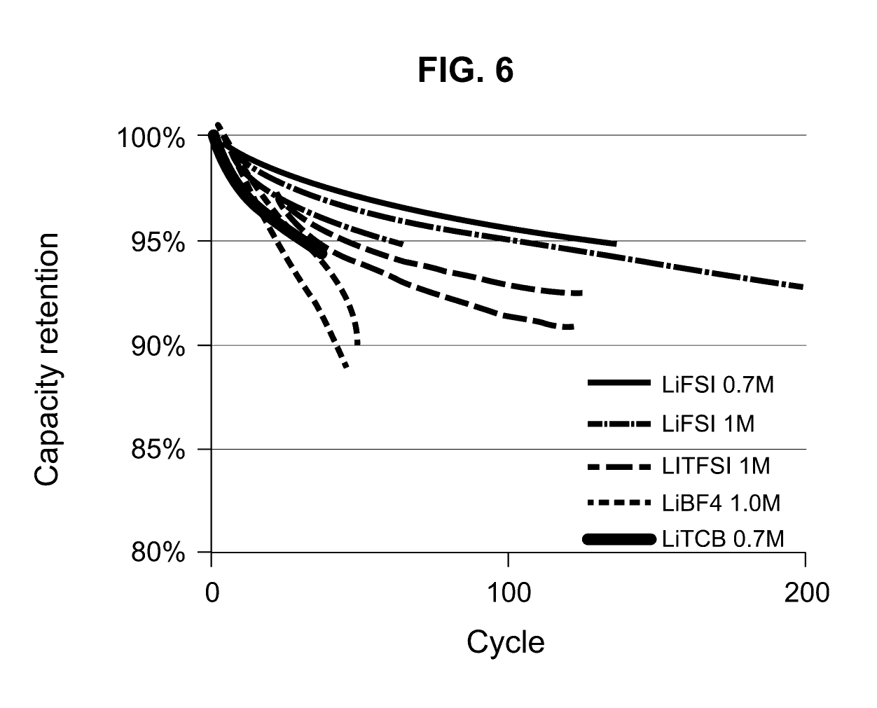

In FIG. 6, a plot of capacity retention vs. number of charge and discharge cycles is provided for electrochemical cells prepared according to various embodiments of the disclosure. The solvent used was EC/GBL at a ratio of 30/70 (with 2% VC, 0.5% TOP), and different electrolyte salts (0.7M LiFSI, 1M LiFSI, 1M LiTFSI, 1M LiBF4 and 0.7M LiTCB) were compared. For LiBF4 compositions, 1.5% LiBOB was also added. For LiTFSI and LiFSI compositions, 0.8% maleic anhydride was added. The cathode and anode thicknesses for the devices shown in FIG. 6 were both 300 μm. As shown, an electrochemical cell prepared using 0.7M LiFSI as a salt had the highest capacity retention throughout the life cycling of the electrochemical cell. Additionally, the 0.7M LiFSI outperformed the 1M LiFSI.

In FIG. 7, comparisons are made between ionic transport properties of electrodes of the present invention and that of a conventional electrode, for the same active loading (as discussed in greater detail above), over a wide range of active volume fraction. Each curve corresponds to a different volume fraction of binder (labeled as percentages in FIG. 7) used in a conventional electrode.

Embodiments described herein relate generally to devices, systems and methods for optimizing a ratio of ionic conductivity to electronic conductivity in semi-solid electrodes for energy storage.

As used herein, the terms “about” and “approximately” generally mean plus or minus 10% of the value stated, for example about 250 μm would include 225 μm to 275 μm, about 1,000 μm would include 900 μm to 1,100 μm.

While various embodiments of the system, methods and devices have been described above, it should be understood that they have been presented by way of example only, and not limitation. The embodiments have been particularly shown and described, but it will be understood that various changes in form and details may be made.

1. An energy storage device, comprising:
a positive electrode current collector, a negative electrode current collector and a separator disposed between the positive electrode current collector and the negative electrode current collector,
the separator spaced from the positive electrode current collector and at least partially defining a positive electroactive zone,
the separator spaced from the negative electrode current collector and at least partially defining a negative electroactive zone; and
a semi-solid electrode having a thickness in the range of about 200 to about 2,000 μm disposed in at least one of the positive electroactive zone and the negative electroactive zone, the semi-solid electrode including a suspension of an ion-storing solid phase material in a non-aqueous liquid electrolyte,
the semi-solid electrode having a ratio of electronic conductivity to ionic conductivity greater than about 15.

2. The energy storage device of claim 1, wherein the ratio of electronic conductivity to ionic conductivity is about 15 to about 300.

3. The energy storage device of claim 1, wherein the ratio of electronic conductivity of the semi-solid electrode to the ionic conductivity of the non-aqueous liquid electrolyte is greater than about 15.

4. The energy storage device of claim 2, wherein the ratio of electronic conductivity to ionic conductivity is about 20 to about 100.

5. The energy storage device of claim 2, wherein the ratio of electronic conductivity to ionic conductivity is about 30 to about 75.

6. The energy storage device of claim 1, wherein the electronic conductivity of the semi-solid electrode is about 100 mS/cm to about 2,000 mS/cm.

7. The energy storage device of claim 1, wherein the ionic conductivity of the semi-solid electrode is about 5 mS/cm to about 15 mS/cm.

8. The energy storage device of claim 1, wherein the ionic conductivity of the non-aqueous liquid electrolyte is about 5 mS/cm to about 15 mS/cm.

9. The energy storage device of claim 8, wherein the ionic conductivity of the non-aqueous liquid electrolyte is about 9 mS/cm to about 12 mS/cm.

10. The energy storage device of claim 9, wherein the non-aqueous liquid electrolyte comprises lithium bis(fluorosulfonyl)imide (LIFSI).

11. The energy storage device of claim 8, wherein the ionic conductivity of the non-aqueous liquid electrolyte is about 5 mS/cm.

12. The energy storage device of claim 8, wherein the ionic conductivity of the non-aqueous liquid electrolyte is about 7 mS/cm.

13. The energy storage device of claim 8, wherein the ionic conductivity of the non-aqueous liquid electrolyte is about 9 mS/cm.

14. The energy storage device of claim 1, wherein a salt concentration in the non-aqueous liquid electrolyte is less than about 1.33M.

15. The energy storage device of claim 14, wherein the salt concentration in the non-aqueous liquid electrolyte is about 0.4M to about 1.33M.

16. The energy storage device of claim 15, wherein the salt concentration in the non-aqueous liquid electrolyte is about 0.5M to about 1.0M.

17. The energy storage device of claim 16, wherein the salt concentration in the non-aqueous liquid electrolyte is about 0.6M to about 0.9M.

18. An energy storage device, comprising:
a positive electrode current collector, a negative electrode current collector, and a separator separating the positive current collector and the negative current collector;
a positive electrode disposed between the positive electrode current collector and the separator; the positive electrode current collector and the separator defining a positive electroactive zone accommodating the positive electrode; and
a negative electrode disposed between the negative electrode current collector and the separator; the negative electrode current collector and the separator defining a negative electroactive zone accommodating the negative electrode,
wherein at least one of the positive electrode and the negative electrode includes a semi-solid electrode having a thickness in the range of about 200 μm to about 2,000 μm, the semi-solid electrode including a suspension of an ion-storing solid phase material in a non-aqueous liquid electrolyte, the semi-solid electrode having a ratio of electronic conductivity to ionic conductivity greater than about 15.

19. An energy storage device, comprising:
a positive electrode current collector, a negative electrode current collector and a separator disposed between the positive electrode current collector and the negative electrode current collector,
the separator spaced from the positive electrode current collector and at least partially defining a positive electroactive zone,
the separator spaced from the negative electrode current collector and at least partially defining a negative electroactive zone; and
a semi-solid electrode having a thickness in the range of about 200 μm to about 2,000 μm disposed in at least one of the positive electroactive zone and the negative electroactive zone, the semi-solid electrode including a suspension of an ion-storing solid phase material in a non-aqueous liquid electrolyte, the semi-solid electrode having an electronic conductivity of at least about 150 mS/cm and an ionic conductivity of less than about 10 mS/cm.

20. The energy storage device of claim 19, wherein a ratio of the electronic conductivity to the ionic conductivity is about 15 to about 300.

21. The energy storage device of claim 19, wherein the ratio of electronic conductivity of the semi-solid electrode to the ionic conductivity of the non-aqueous liquid electrolyte is greater than about 15.

22. The energy storage device of claim 20, wherein the ratio of the electronic conductivity to the ionic conductivity is about 20 to about 100.

23. The energy storage device of claim 22, wherein the ratio of the electronic conductivity to the ionic conductivity is about 30 to about 75.

24. The energy storage device of claim 19, wherein a salt concentration in the non-aqueous liquid electrolyte is less than about 1.33M.

25. The energy storage device of claim 24, wherein the salt concentration in the non-aqueous liquid electrolyte is about 0.4M to about 1.33M.

26. The energy storage device of claim 25, wherein the salt concentration in the non-aqueous liquid electrolyte is about 0.5M to about 1.0M.

27. The energy storage device of claim 26, wherein the salt concentration in the non-aqueous liquid electrolyte is about 0.6M to about 0.9M.

28. An electrochemical cell comprising:
a cathode;
a semi-solid anode including a suspension of about 40% to about 75% by volume of an active material and 0% to about 10% by volume of a conductive material in a non-aqueous liquid electrolyte; and
a separator disposed between the semi-solid anode and the cathode,
wherein, the semi-solid anode has a thickness in the range of about 200 μm to about 2,000 μm, the semi-solid anode has an electronic conductivity of at least about 100 mS/cm, the semi-solid anode has an ionic conductivity of less than about 10 mS/cm, and the ratio of electronic conductivity to ionic conductivity is greater than about 15.

29. An electrode for use in a rechargeable battery, the electrode comprising:
an electrode compartment defined at least partially by a current collector and a separator, the electrode compartment having a thickness of about 200 μm to about 2,000 μm, the electrode compartment configured to contain an electroactive composition capable of taking up or releasing ions, the electroactive composition including a suspension of an ion-storing solid phase material in a non-aqueous liquid electrolyte;
wherein
the volume fraction of the solid ion-storing redox material is between about 35% and 75%,
the electroactive composition has an electronic conductivity of at least about 100 mS/cm, and
the salt concentration in the non-aqueous liquid electrolyte is less than about 1.33M.

30. The electrode according to claim 29, wherein an effective ionic transport length of the electrode is from about 750 μm to about 10,000 μm.
